(19) United States
(12) Patent Application Publication
(10) Pub. No.: US 2024/0341516 A1
(43) Pub. Date: Oct. 17, 2024

(54) ELectric kettle with a cover that can be opened automatically at a constant speed

(71) Applicants: Zhirong Zhou, Guangdong Province (CN); Zhijun Yu, Guangdong Province (CN)

(72) Inventors: Zhirong Zhou, Guangdong Province (CN); Zhijun Yu, Guangdong Province (CN)

(21) Appl. No.: 18/135,209

(22) Filed: Apr. 17, 2023

(51) Int. Cl. A47J 27/21

(52) U.S. Cl. CPC A47J 27/21175; A47J 27/21008

(57) ABSTRACT

The invention provides an electric kettle with a lid that can be automatically opened at a constant speed, which relates to the technical field of electric kettles, and includes an electric kettle body. The lower end of the lower cover is fixedly connected with a guide rail cover, the inner surface of the electric kettle body is fixed with a guide rail, and the upper surface of the electric kettle body is provided with a button, and the spring force will pull the guide rail cover fixed on the guide rail, and then automatically complete In the action of opening the lid, the constant force spring can provide uniform power, and it is used in conjunction with the damper to achieve a state of uniform elastic force, uniform and stable movement process; the double guide rail structure is used to ensure that the lid will not shake during movement. Swing; and the use of silicone rings and thin ribs can scrape off the high-temperature water droplets on the lower cover during the process of opening the lid, so that the water droplets will not fall off and burn your hands, so that the speed of opening the lid can be constant, no abnormal sound and preventing burns, although the structure is simple.

### TECHNICAL FIELD

The invention relates to the technical field of electric kettles, in particular to an electric kettle with a cover that can be automatically opened at a constant speed.

### DESCRIPTION OF RELATED ART

An electric kettle is a fast, safe and convenient household appliance. It usually has functions such as intelligent steam induction temperature control, automatic power off after boiling, and dry-boiling prevention. With the improvement of living standards, people's experience requirements for household appliances is getting higher and higher. The current method of opening the lid of the kettle is generally pressing the button, the lid rotates through the shaft at the handle of the kettle, and the position of the lid close to the spout of the kettle begins to lift up to achieve the purpose of opening the lid. However, this kind of lid opening method has the following issues: 1. The buttons are generally on the top of the cover, and it is easy to be scalded by steam when opening the cover; 2. Due to structural reasons, when the cover is opened too fast, the impact force is big, and the high-temperature water droplets condensed on the bottom of the cover are easy to pop out. It is easy to be burnt when water splashed on the human body. Therefore, an electric kettle with automatic opening cover at a constant speed is provided.

### CONTENTS OF THE INVENTION

The purpose of the present this invention is to solve the shortcoming of existing technology, provide a kind of electric kettle that automatically opens the lid at a constant speed.

In order to achieve the above object, the present invention adopts the following technical solution: an electric kettle with a constant speed and automatic opening cover, comprising an electric kettle body, an upper cover is designed on the upper end of the electric kettle body, and a lower end is fixedly installed on the lower end of the upper cover. cover, the lower end of the lower cover is fixedly connected with a guide rail sleeve, the inner surface of the electric kettle body is fixed with a guide rail, the upper surface of the electric kettle body is provided with a button, and the inner surface of the electric kettle body is provided with a connecting Rod and ejector rod, the outer surfaces of the connecting rod and the ejector rod are both sleeved with springs, the inner surface of the electric kettle body is fixed with a fixed plate, and the lower end of the fixed plate is rotatably connected with a cord storage box. The outer surface of the cord storage box is covered with a pull wire, the surface of the cord storage box is provided with a constant force spring, and the surface of the cord storage box is provided with a damper.

In order to install the damper, the invention is improved as follows: the surface of the cord storage box is fixedly installed with a damper interface.

In order to pull the guide rail cover, the present invention improvement is as following: one or more pull wire rings are fixedly connected to the inner surface of the electric kettle body, one end of the pull wire is fixedly connected to the pull wire ring, and the other end of the pull wire is fixed to the guide rail sleeve.

In order to improve the strength of the pull wire, the present invention improved pull wire material to thin stainless steel wire, nylon wire or flexible wire body with high tensile strength, and the damper can also be a gear box structure.

In order to scrape off the high-temperature water droplets on the lower cover, the present invention is improved as follows: the inner surface of the electric kettle body is fixedly connected with a silicone ring, and the upper end of the silicone ring is provided with a thin rib.

In order to make the push rod move downward, the present invention is improved as follows: one side of the connecting rod is provided with a slope a, and the lower end of the push rod is provided with a slope b.

In order to make the kettle cover move along the guide rail, after improved the present invention, the guide rail is smoothly connected with the guide rail sleeve.

In the present invention, in order to solve the above problems, using a constant force spring, a wire cord storage box, a pull wire and a damper. When the cover is closed, the pull wire will pull the constant force spring to move. Except for the fixed plate, other components will rotate together with the pull wire until the top rod slide into the groove of the lower cover. Press the button when opening the cover, the spring force will pull the guide rail sleeve fixed on the guide rail, and then automatically complete the opening action. Among them, the constant force spring can provide equally power and use together with the damper to achieve a state of equal elastic force, equal and stable movement process; With double guide rail structure to ensure that the lid will not shake or swing during movement. Open the lid during the process by using silicone ring and thin ribs, the high-temperature water droplets on the lower cover are scraped off, so that the water droplets will not fall off and burn your hands, so that with a simple structure, the speed of opening the cover is consistent, there is no abnormal sound, and the purpose of preventing burns is achieved.

### DESCRIPTION OF DRAWINGS

FIG. 1 is the top view of an electric kettle with a constant speed and automatic opening lid proposed by the present invention;

FIG. 2 is a partial structural side sectional view of an electric kettle with a constant speed and automatic opening lid proposed by the present invention;

FIG. 3 is a schematic structural view of the connecting rod and ejector rod in FIG. 2 in an electric kettle with a constant speed and automatic opening lid proposed by the present invention;

FIG. 4 is a schematic structural view of a take-up box in an electric kettle with a uniform and automatic opening lid proposed by the present invention;

FIG. 5 is a structural schematic diagram of an upper cover and a lower cover in an electric kettle with an automatic opening lid at a constant speed proposed by the present invention;

FIG. 6 is a top exploded view of an electric kettle with a constant speed and automatic opening lid proposed by the present invention.

FIG. 7 is a side sectional view of an electric kettle with a constant speed and automatic opening lid proposed by the present invention.

### ILLUSTRATION

1. Electric kettle body; 2. Upper cover; 3. Lower cover; 4. Guide rail cover; 5. Guide rail; 6. Button; 7. Connecting rod; 8. Push rod; 9. Spring; 10. Fixed plate; 11. Cord storage box; 12. Pull wire; 13. Constant force spring; 14. Damper; 15. Damper interface; 16. Silicone ring; 17. Thin tendons; 18. Pull ring

### DETAILED IMPLEMENT METHOD

In order to understand the above objects, features and advantages of the present invention more clearly, the present invention will be further described below in conjunction with the accompanying drawings and embodiment. It should be noted that, in the case of no conflict, the embodiment of the present application and the features in the embodiment can be combined with each other.

In the following description, many specific details are set forth in order to fully understand the present invention. However, the present invention can also be implemented in other ways than those described here. Therefore, the present invention is not limited to the specific embodiment disclosed in the description below.

### Embodiment One

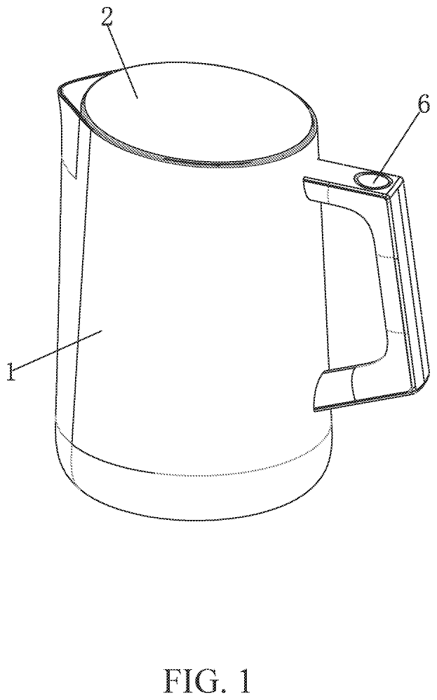

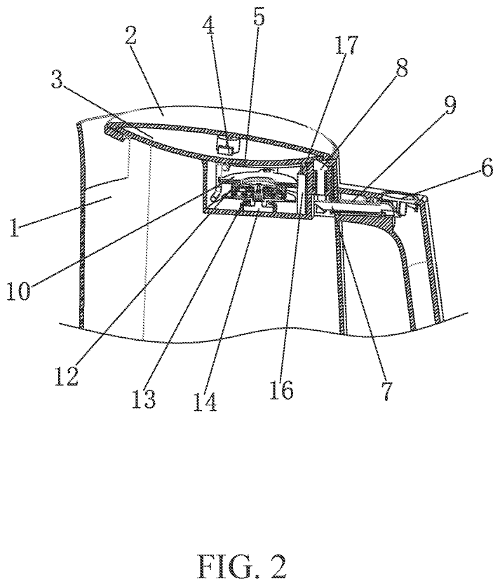

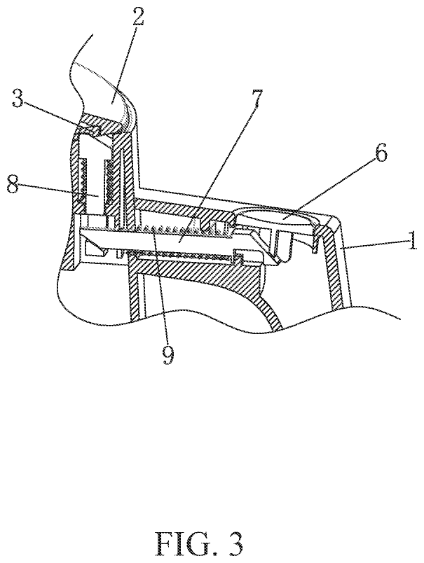

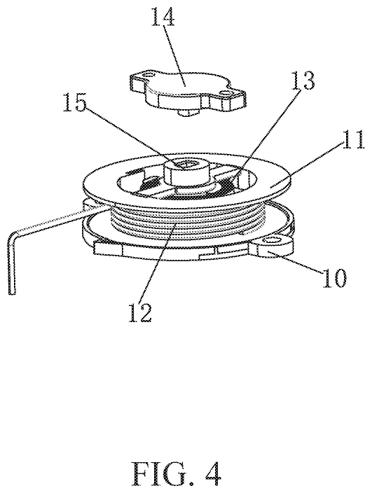

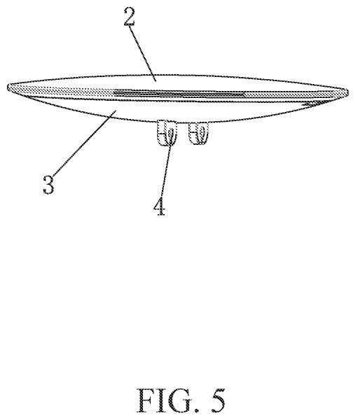

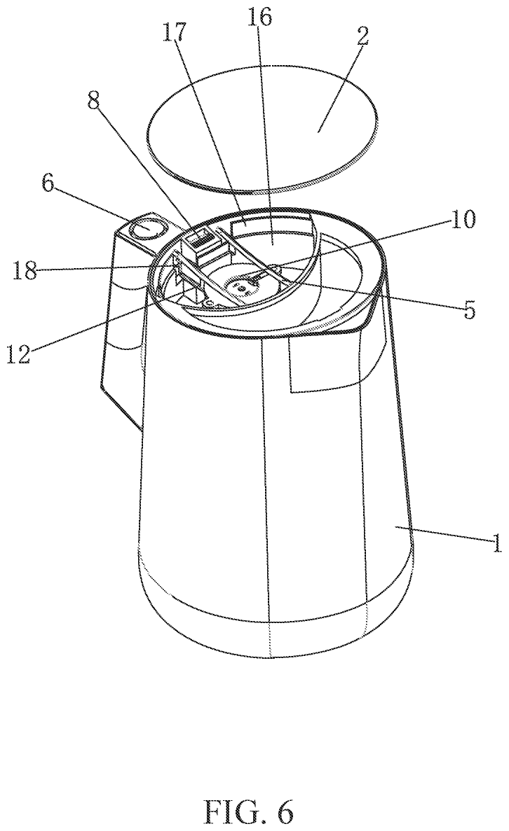

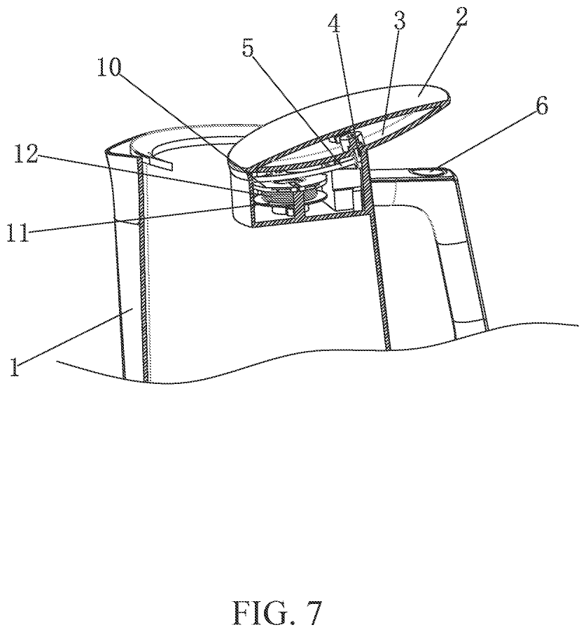

Please refer to FIGS. 1-7, the present invention provides a technical solution: an electric kettle with a even speed and automatic opening lid, including an electric kettle body 1, an upper end of the electric kettle body 1 is provided with an upper cover 2, and the lower end of the upper cover 2 is fixed. There is a lower cover 3, the lower end of the lower cover 3 is fixedly connected with a guide rail cover 4, the inner surface of the electric kettle body 1 is fixed with a guide rail 5, and the lower end of the lower cover 3 is fixedly connected with the guide rail cover 4, and the electric kettle body 1 is set at the same time The inner surface of the electric kettle body 1 is fixed with a guide rail 5. During the process of opening the cover, the guide rail cover 4 will move along the surface of the guide rail 5. The upper surface of the electric kettle body 1 is provided with a button 6, and the inner surface of the electric kettle body 1 is provided with a connecting rod. 7 and ejector rod 8, by being provided with button 6 on the upper surface of electric kettle body 1, and connecting rod 7 and ejector rod 8 are arranged on the inner surface of electric kettle body 1 simultaneously, when button 6 is pressed, connecting rod 7 moves to the left Movement, the slope a at the rightmost end of the connecting rod 7 withstands the slope b of the ejector rod 8, the ejector rod 8 moves downward, the lower shell is disengaged from the button position of the ejector rod 8, and the cover automatically moves towards the handle through the assembly of the take-up box 11. A button 6 is provided on the upper surface of the electric kettle body 1, and a connecting rod 7 and a push rod 8 are provided on the inner surface of the electric kettle body 1, and springs 9 are sleeved on the outer surfaces of the connecting rod 7 and the push rod 8, By arranging the outer surfaces of the connecting rod 7 and the ejector rod 8 to be covered with a spring 9, the spring 9 will reset the changed position of the connecting rod 7 and the ejector rod 8, and the inner surface of the electric kettle body 1 is fixed with a fixing plate 10, The inner surface of the electric kettle body 1 is fixedly equipped with a fixed plate 10, which is used to install the cord storage box 11 on the electric kettle body 1. The lower end of the fixed plate 10 is rotatable connected with the cord storage box 11. The surface is covered with a pull wire 12, and the surface of the cord storage box 11 is provided with a constant force spring 13. By setting the outer surface of the cord storage box 11, the pull wire 12 is set, and at the same time, the surface of the cord storage box 11 is provided with a constant force spring 13. When the cover is closed, the pull wire 12 will pull the constant force spring 13 to move, and the whole assembly except the fixed plate 10 will rotate together with the pull wire 12 until the push rod 8 slides into the groove of the lower cover 3, and when the button 6 is pressed, The spring force will drive the guide rail cover 4 to move, and the surface of the wire cord storage box 11 is provided with a damper 14, and the surface of the wire cord storage box 11 is provided with a damper 14 to achieve the purpose of uniform elastic force. The damper 14 can also adopt a gear box structure to achieve the damping effect.

Please refer to FIG. 1-7, the surface of the cord storage box 11 is fixedly installed with a damper interface 15, and the surface of the cord storage box 11 is fixedly installed with a damper interface 15 for installing the damper 14 on the cord storage box 11, the inner surface of the electric kettle body 1 is fixedly connected with one or more stay wire rings 18, one end of the stay wire 12 is fixedly connected with the stay wire ring 18, and the inner surface of the electric kettle body 1 is fixedly connected with one or more stay wire rings 18, One end of back-guy 12 is set to be fixedly connected with back-guy ring 18 simultaneously, and back-guy ring 18 can fix the direction of 12 pulling forces of back-guy, and the other end of back-guy 12 is fixed with guide rail cover 4, and the material of back-guy 12 is thin stainless steel wire, nylon wire or high-resistant Tensile flexible wire body is used to increase the strength of the pull wire 12 by setting the material of the pull wire 12 as thin stainless steel wire, nylon wire or high-strength flexible wire body. The damper 14 can also be a gear box structure. The electric kettle body 1 The inner surface of the electric kettle body 1 is fixedly connected with a silicone ring 16, and the upper end of the silicone ring 16 is provided with a thin rib sheet 17, and the inner surface of the electric kettle body 1 is fixedly connected with a silicone ring 16, and the upper end of the silicone ring 16 is provided with a thin rib sheet 17. In the process of opening the cover, the thin rib sheet 17 will scrape off the high-temperature water droplets on the lower cover 3, the side of the connecting rod 7 is provided with a slope a, and the lower end of the ejector rod 8 is provided with a slope b, through which the connecting rod 7 A slope a is provided on one side of the push rod 8, and a slope b is provided at the lower end of the push rod 8. The slope a of the connecting rod 7 can withstand the slope b of the push rod 8, so that the push rod 8 can move downward, and the guide rail 5 and the guide rail sleeve 4 Swipe to connect.

Working principle: when in use, the constant force spring 13 provides power, the damper 14 ensures a relatively uniform movement, the two-way guide rail 5 ensures uniform force during the movement of the lid, and the pull wire 12 is designed to ensure the maximum stroke. When closing the lid, A force is applied from the outside to close the lid manually, and the lid moves toward the spout through the guide rail cover 4. Since the guide rail cover 4 is connected to the pull wire 12, the guide rail cover 4 pulls the pull wire 12, and the constant force spring 13 is closed. After the cover is in place, the lower cover 3 is close The push rod 8 is snapped into the groove at the handle position, and the cover is closed at this time. When the cover is to be opened, the button 6 is pressed first, the connecting rod 7 is pressed by the button 6 to move to the left, and the rightmost end of the connecting rod 7 pushes Hold the lower end of the ejector rod 8, and use the inclined plane a and the inclined plane b to move the ejector rod 8 downward, and the groove in the lower cover 3 is disengaged from the ejector rod 8. At this time, the constant force spring 13 is naturally relaxed and pulled by the pull wire 12. The guide rail cover 4 on the cover approaches the handle direction, and the guide rail cover 4 then slides on the guide rail 5. After the guide rail cover 4 moved to the end of the guide rail 5, the lid stopped moving, and now the uncapping action was completed.

The above is only a preferred embodiment of the present invention, and is not intended to limit the present invention to other forms. Any skilled person who is familiar with this profession may use the technical content disclosed above to change or remodel it into an equivalent change. The embodiment are applied to other fields, but any simple modifications, equivalent changes and modifications made to the above embodiment according to the technical essence of the present invention still belong to the protection scope of the technical solutions of the present invention without departing from the content of the technical solutions of the present invention.

What is claimed is:

1. An electric kettle that can automatically open the lid at a constant speed, comprising an electric kettle body, characterized in that: the upper end of the electric kettle body is provided with an upper cover, and the lower end of the upper cover is fixed A lower cover is installed, the lower end of the lower cover is fixedly connected with a guide rail cover, the inner surface of the electric kettle body is fixed with a guide rail, and the electric kettle body The upper surface of is provided with a button, and the inner surface of the electric kettle body is provided with a connecting rod and a push rod, and the connecting rod and the push rod are equipped with springs on the outer surface, and the inner surface of the electric kettle body is fixed with a fixed plate, and the lower end of the fixed plate is connected with a cord storage box in rotation, the outer surface of the cord storage box is covered with a pull wire, the surface of the cord storage box is provided with a constant force spring, and the surface of the cord storage box A damper is provided.

2. The electric kettle with a cover that can be opened automatically at a constant speed according to patent claim 1, characterized in that: a damper interface is fixedly installed on the surface of the cord storage box.

3. The electric kettle with automatic cover opening at a constant speed according to patent claim 1, characterized in that: the inner surface of the electric kettle body is fixedly connected with one or more pull wire rings, and the pull wires One end is fixedly connected with the pull wire ring, and the other end of the pull wire is fixedly mounted with the guide rail cover.

4. The electric kettle with automatic opening lid at a constant speed according to patent claim 1, characterized in that: the pull wire is made of thin stainless steel wire, nylon wire or flexible wire with high tensile resistance, and the damper. It can also be a gear box structure.

5. The electric kettle with automatic opening lid at a constant speed according to patent claim 1, characterized in that: the inner surface of the electric kettle body is fixedly connected with a silicone ring, and the upper end of the silicone ring is provided with thin tendon sheet.

6. The electric kettle with automatic opening lid at a constant speed according to patent claim 1, characterized in that: one side of the connecting rod is provided with a slope a, and the lower end of the push rod is provided with a slope b.

7. The electric kettle with a cover that can be automatically opened at a constant speed according to patent claim 1, wherein the guide rail is slidingly connected to the guide rail cover.
